(19) United States
(12) Patent Application Publication
(10) Pub. No.: US 2002/0071035 A1
(43) Pub. Date: Jun. 13, 2002

(54) Digital camera docking station

(76) Inventor: Robert E. Sobol, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/731,599

(22) Filed: Dec. 7, 2000

(51) Int. Cl. H04N 5/225

(52) U.S. Cl. 348/207; 348/373; 348/372

(57) ABSTRACT

A printer has a holding portion attached thereto that is adapted to receive an imaging device. The printer and the imaging device have transceivers that communicate with each other upon the placement of the imaging device into the holding portion. The transceivers transmit image data representative of images generated by the imaging device to the printer. The printer, upon receipt of image data representative of a whole image, prints the image without any user intervention. While the imaging device is located within the holding portion, the printer provides power to the imaging device to operate its processors and to recharge its batteries.

### TECHNICAL FIELD OF THE INVENTION

The present invention relates to a digital camera docking station and, more particularly, to a printer having a cradle that serves to hold a digital camera, wherein communications are established between the camera and the printer when the camera is located within the cradle. The communications may cause image data to be automatically downloaded from the camera to the printer.

### BACKGROUND OF THE INVENTION

A digital camera converts two-dimensional images of objects to machine-readable image data (sometimes referred herein simply as “image data”). The image data is typically binary data that is representative of an object and is used to replicate the images of the object at a later time. For example, image data representative of a plurality of images may be stored in a conventional computer. The computer processes the image data and displays the images on a video monitor or uses a printer to print the images. The image data may also be transmitted via an electronic transmission to a remote computer that replicates the images.

A digital camera typically has a two-dimensional photosensing array consisting of several million photodetecting elements that generate image data representative of images of objects. Each of the photodetecting elements generates a data value that is representative of one discrete picture element or “pixel” of the image of the object. Accordingly, the image data representing even an image of a simple object may consist of several million values in addition to data that correlates the image data to the location on the two-dimensional array from where it was generated. The image data is typically compressed by a conventional data compression technique. The compressed image data, however, typically remains very large.

Image data representing a plurality of images of different objects is stored within the digital camera until it can be downloaded to a more permanent storage device, such as a hard drive or optical disc associated with a computer. The image data may also be downloaded directly to a printer which, upon a series of commands entered by a user, prints the images.

There are generally two different methods of downloading image data from a digital camera. In a first method, the image data is transmitted via a transmission means, such as a cable or an infrared transmitter, to a computer or a printer. This form of downloading image data has several disadvantages. For example, the time to download the image data representative of several images is relatively long and causes a significant drain on batteries used by the camera. In the case of an infrared transmission, the digital camera must be maintained in close proximity to the computer or printer so that there is no interference with the infrared transmission. Interferences with the infrared transmission will cause errors in the image data, resulting in incorrect replications of the images.

The second downloading method requires removal of a memory device from the digital camera and insertion of the memory device into a computer or a printer. One disadvantage to the removable memory devices is that they render the digital camera dysfunctional when they are removed from the digital camera. For example, if a memory device is removed from the digital camera in order to print images stored thereon, the digital camera is rendered dysfunctional during the period that the memory device is removed. Furthermore, when a memory device is inserted into the printer, the user has to operate a control panel associated with the printer to select and print desired images. This operation of the control panel can be confusing and burdensome to some users. The control panel typically does not have a viewing device that allows the user a chance to view images before they are printed. Therefore, the user typically is not able to view the images prior to printing them, which typically results in duplicate images being printed.

A need exists for a device that overcomes some or all of these problems.

### SUMMARY OF THE INVENTION

The present invention is directed toward a docking station that is adapted to facilitate the downloading of image data from an imaging device, such as a digital camera. The camera may have a transceiver associated therewith that is adapted to output image data and otherwise communicate with a transceiver associated with the docking station. For example, the camera may have an infrared port or an electrical contact that is adapted to communicate with a similar infrared port or electrical contact located on the docking station. The docking station may have a holding mechanism, such as a cradle, formed therein that is appropriately sized to receive the camera. The transceivers in the camera and the transceiver in the docking station may be appropriately positioned so that they may become operatively associated with each other when the camera is placed into the cradle or located proximate thereto.

When a user places the camera into the cradle, an instruction may be automatically transmitted to processing devices within the camera that cause image data stored within the camera to be transmitted to the docking station. The docking station may have a computer or processor located therein to which the image data is forwarded. Accordingly, the image data stored within the camera may be downloaded to the docking station simply by placing the camera into the cradle.

In one embodiment, the docking station is a printer. The image data stored in the camera may be downloaded directly to the printer where it is instantaneously printed without any other user intervention. A subsequent transmission may be made to the camera indicating that the image data was successfully downloaded.

### BRIEF DESCRIPTION OF THE DRAWINGS

FIG. 1 is a top perspective view of a printer having a cradle formed therein.

FIG. 2 is a bottom perspective view of a digital camera of the type that may be positioned within the cradle of FIG. 1.

FIG. 3 is a schematic illustration of the mechanical and electrical interfaces between the camera of FIG. 2 and the printer of FIG. 1.

FIG. 4 is a flow chart illustrating the operation of the digital camera and the printer of FIG. 3.

FIG. 5 is a top perspective view of a printer as in FIG. 1, wherein a tray replaces the cradle.

FIG. 6 is a top perspective view of a printer as in FIG. 1, wherein pins replace the cradle.

FIG. 7 is a schematic illustration of a computer system having a computer and a printer attached to a base unit.

### DETAILED DESCRIPTION OF THE INVENTION

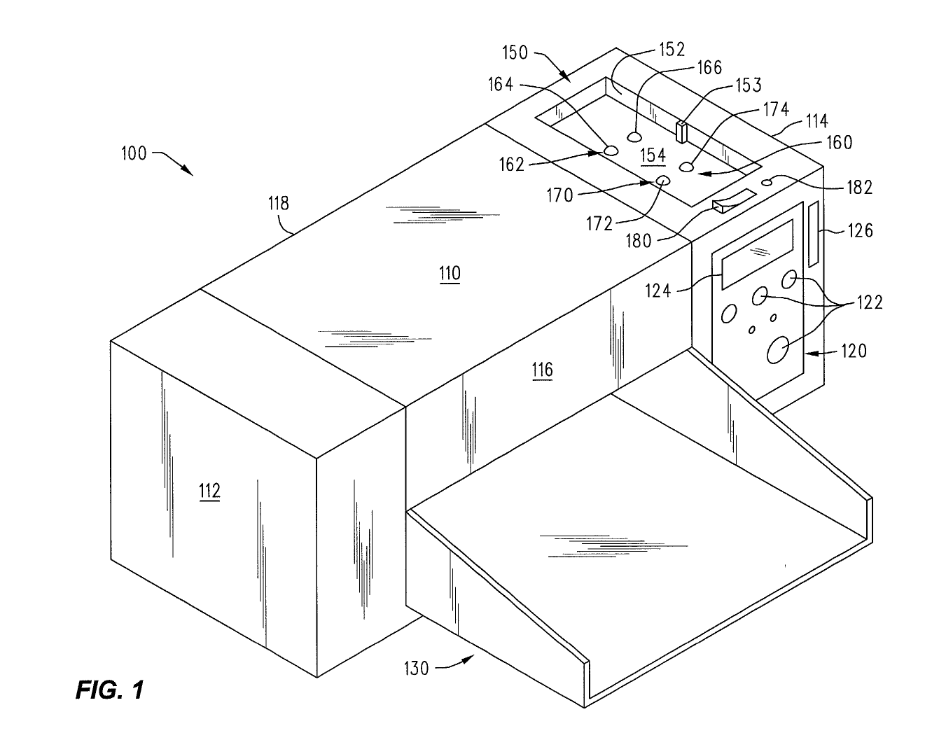

FIGS. 1 through 7, in general, illustrate an imaging device docking station 100 comprising a holding portion 150 (sometimes referred to as a cradle) adapted to receive an imaging device 200, such as a digital camera and a receiver adapted to receive image data from the imaging device 200 when the imaging device 200 is located proximate the holding portion 150.

FIGS. 1 through 7 also, in general, illustrate a method for transferring data from an imaging device 200 to an electronic device 100. The method comprises: locating the imaging device 200 in the proximity of the electronic device 100; detecting the presence of the imaging device 200 in the proximity of the electronic device 200; and transferring the data from the imaging device 200 to the electronic device 100 upon the detection of the imaging device 200 in the proximity of the electronic device 100.

Having generally described the holding mechanism 150 and a method of downloading data from a digital camera 200, they will now be described in greater detail.

Referring to FIG. 1, which is a top perspective view of a printer 100, the holding portion 150 (sometimes referred to as a cradle) described above is, for non-limiting illustration purposes, described herein as being integrally formed into the printer 100. Accordingly, the printer 100 may be a main body portion relative to the cradle 150 and the cradle 150 may be an integral portion of the printer. It is to be understood that devices other than the printer 100 may be adapted to have a holding portion associated therewith and to function as the above-described holding portion. Except for the inventive concepts described herein, the printer 100 may, as a non-limiting example, be of the type commercially available from the Hewlett-Packard Company as a PhotoSmart model P1100. Unlike many conventional printers, the printer 100 described herein may function without being connected to or otherwise communicating with a separate computer.

The printer 100 may have a top portion 110, a left portion 112, a right portion 114, a front portion 116, and a rear portion 118. The front portion 116 of the printer 100 may have a control panel 120 located thereon. The control panel 120 may have a plurality of buttons 122 and a display panel 124. The control panel 120 may serve as an interface between a user and the printer 100. For example, instructions may be delivered to the printer 100 by way of the buttons 122. Likewise, messages and instructions may be conveyed to a user by way of the display 124. The front portion 116 may also have a card slot 126 formed therein. The card slot 126 may be appropriately sized to accommodate conventional removable data storage devices used by digital cameras. Such removable data storage devices include magnetic, optical, and semiconductor devices. As described in greater detail below, some embodiments of the printer 100 do not have the control panel 120 or the card slot 126.

A conventional paper handling mechanism 130 may be formed into the printer 100 and may be associated with the front portion 116 of the printer 100. The paper handling mechanism 130 may serve as an input and an output for paper used by the printer 100. It is to be understood that the paper handling mechanism 130 may be associated with virtually any portion or portions of the printer 100.

The top portion 110 of the printer 100 may have a cradle 150, sometimes referred to as a holding mechanism, formed therein. In the embodiment of the printer 100 shown in FIG. 1, the cradle 150 is recessed into the top portion 110 of the printer 100. The cradle 150 may have a perimeter surface 152 that is substantially the same shape as a digital camera and slightly larger than a digital camera. Accordingly, the size and shape of the perimeter surface 152 permits the cradle 150 to receive a digital camera as is described in greater detail below. The perimeter surface 152 may have a protrusion 153 or the like extending therefrom. The protrusion 153 serves to properly align the camera within the cradle 150. The cradle 150 may also have a lower surface 154 on which the digital camera sits when it is located within the cradle 150. It should be noted that the shape of the perimeter surface 152 may not be symmetric. With an asymmetric perimeter surface 152, the digital camera may only fit into the cradle 150 in one direction, i.e., so that the front of the digital camera will only face the right portion 114 of the printer 100. Accordingly, an asymmetric perimeter surface 152 assures proper alignment between the printer 100 and the digital camera without the use of the protrusion 153. It should be noted that while the description provided herein focuses on the cradle 150 being adapted to hold a digital camera, the cradle 150 may be also adapted to hold other imaging devices. For example, the cradle 150 may be adapted to hold a hand-held scanning device.

A plurality of electric terminals 160 may be located within the cradle 150. In the non-limiting example of FIG. 1, the terminals 160 are located on the lower surface 154 of the cradle 150. The terminals 160 may be spring loaded and may be biased to extend from the lower surface 154. The terminals 160 may be pushed toward and into the lower surface 154 when the digital camera is placed into the cradle 150. The above-described spring loading causes the terminals 160 to electrically contact the digital camera when it is positioned within the cradle 150. A pair of first terminals 162 may serve to provide electric power to the digital camera. The first terminals 162 may have a positive terminal 164 and a ground terminal 166, wherein an electric potential may exist between the positive terminal 164 and the ground terminal 166. A pair of second terminals 170 may also be located on the lower surface 154 of the cradle 150 and may serve to transmit data between the digital camera and the printer 100. The second terminals 170 may have a signal terminal 172 that operates at a potential relative to a neutral terminal 174.

As described in greater detail below, the digital camera may have electric terminals or other conductors that correspond to the terminals 160 located in the cradle 150. Accordingly, when the digital camera is positioned within the cradle 150, the terminals 160 contact the conductors attached to the camera and facilitate the transfer of data and electric power. This contact is sometimes referred to as operatively associating the digital camera to the printer 100.

The top portion 110 of the printer 100 may have a switch 180 and an indicator 182 located thereon. The switch 180 may, as a non-limiting example, have a first operative position and a second operative position. The first operative position may permit the transfer of data between the digital camera and the printer 100. The second operative position may prevent the transfer of data between the digital camera and the printer 100. The first and second operative positions of the switch 180 are described in greater detail below. The indicator 182 may, as an example, be a conventional light-emitting diode and may indicate that the digital camera is properly positioned within the cradle 150 as is described in greater detail below. In addition, the indicator 182 may also indicate that batteries within the digital camera are being charged. In one embodiment of the printer 100, the printer 100 only has the switch 180 and the indicator 182 as user interfaces, the control panel 120 is not present.

Having described an embodiment of the printer 100, an example of a digital camera that operates with the printer 100 will now be described.

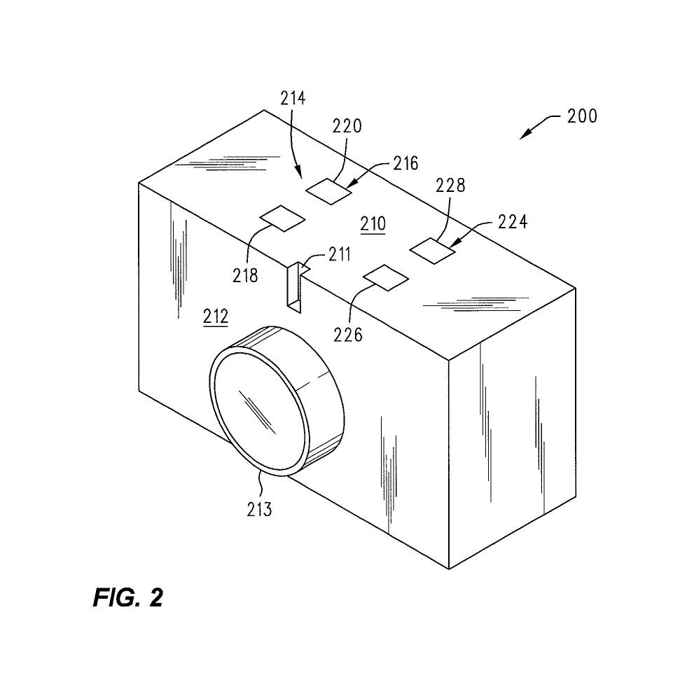

FIG. 2 shows a bottom perspective view of a digital camera 200. Except for the inventive concepts described herein, the digital camera 200 may function in a substantially similar manner as a conventional digital camera. As a non-limiting example, the digital camera 200 may, except for the inventive concepts described herein, function in a substantially similar manner as a digital camera commercially available from the Hewlett-Packard Company and sold under the product name, PhotoSmart.

The digital camera 200 may have a lower surface 210, a front surface 212, and other conventional surfaces. The lower surface 210 and the front surface 212 may have a notch 211 formed therein. The notch 211 may be appropriately sized and shaped to receive the protrusion 153, FIG. 1, extending from the perimeter surface 152 of the cradle 150. The front surface 212 may also have a conventional lens 213 located therein. When the digital camera 200 is placed within the cradle 150, FIG. 1, of the printer 100, the lens 213 faces the right portion 114 of the printer 100. It should be noted that both the printer 100, FIG. 1, and the digital camera 200 may be adapted so that the digital camera 200 faces virtually any preselected direction when it is located within the cradle 150.

The lower surface 210 may have a plurality of conductors 214 or electric terminals attached thereto. The conductors 214 may be conductive strips that are slightly recessed into the lower surface 210 of the digital camera 200. A pair of first conductors 216 may have a ground conductor 218 and a positive conductor 220. The first conductors 216 may be electrically connected to a rechargeable battery, not shown in FIG. 2, located within the digital camera 200 and may serve to recharge the battery. A pair of second conductors 224 may have a neutral conductor 226 and a signal conductor 228. The second conductors 224 may serve to transmit data between the digital camera 200 and the printer 100, FIG. 1. Referring additionally to FIG. 1, when the digital camera 200 is placed within the cradle 150 of the printer 100, the lower surface 210 of the digital camera 200 is located adjacent the lower surface 154 of the cradle 150. The positive terminal 164 and the ground terminal 166 in the cradle 150 electrically contact the positive conductor 220 and the ground conductor 218 respectively. This electrical contact provides an external source of power for the digital camera as is described in greater detail below. The signal terminal 172 and the neutral terminal 174 in the cradle 150 electrically contact the signal conductor 228 and the neutral conductor 226 respectively. This electrical contact provides for the transmission of data between the printer 100 and the digital camera 200 as is described in greater detail below.

Having described the physical association between the printer 100 and the digital camera 200, their electrical interfaces will now be described.

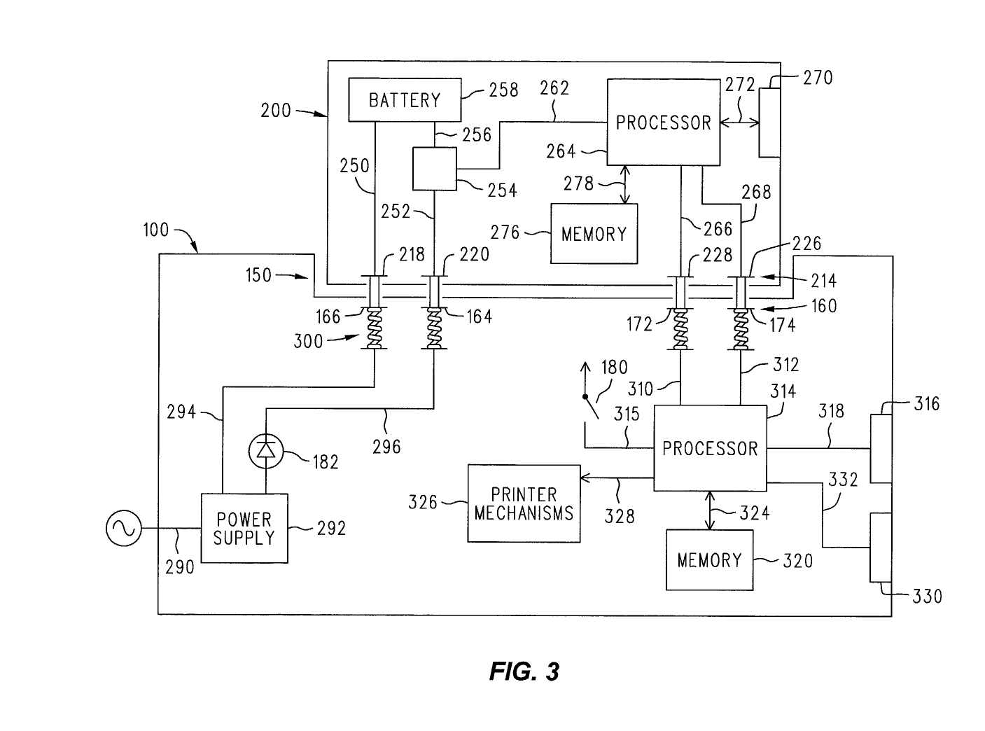

FIG. 3 shows a schematic illustration of a non-limiting example of an interface between the printer 100 and the digital camera 200. FIG. 3 also shows a non-limiting example of the electronic components located within the printer 100 and the digital camera 200 and their respective interconnections. Referring to the digital camera 200, a line 250 is connected to the positive conductor 220 and a line 252 is connected to the ground conductor 218. The term “line” as used herein refers to single and multiple electrical conductors, such as conventional wires or lands on a printed circuit board. The line 252 serves to connect the positive conductor 220 to a current sensor 254. Another line 256 connects the current sensor 254 to a battery 258. The line 250 serves to connect the ground conductor 218 to the battery 258.

A line 262 electrically connects the current sensor 254 to a processor 264. The line 262 may supply a signal to the processor 264 to indicate whether current is flowing between the positive conductor 220 and the battery 258. The current flow indicates that the battery 258 is being charged and that the digital camera 200 is positioned in the cradle 150. A line 266 and a line 268 may connect the processor 264 to the signal conductor 228 and the neutral conductor 226 respectively. The lines 266 and 268 may, as an example, be data lines. A transceiver 270 may be electrically connected to the processor 264 by way of a line 272. The transceiver 270 may serve to both transmit and receive optical signals, such as infrared signals, between the printer 100 and the digital camera 200. A data storage device 276 may be connected to the processor 264 by way of a line 278. The data storage device 276 may, as examples, be a magnetic, an optical, or a semiconductor device. Additionally, the data storage device 276 may be removable from the digital camera 200.

Having described an example of the components of the digital camera 200, a non-limiting example of the components of the printer 100 and their interconnections will now be described. The printer 100 may be powered by way of a conventional power cord 290. The power cord 290 may be electrically connected to a power supply 292 located within the printer 100. The power supply 292 may supply different voltages to power various components of the printer 100. In addition, the power supply 292 may supply power to the digital camera 200 as is described below. A line 294 and a line 296 may electrically connect the power supply 292 to the ground terminal 166 and the positive terminal 164 respectively. The indicator 182, as described above, may be a conventional light-emitting diode and may be connected in the line 296. Accordingly, the indicator 182 emits light when current flows in the line 296, which is indicative of the digital camera 200 being located within the cradle 150 and the battery 258 being charged.

As shown in FIG. 3, a plurality of detent mechanisms 300, such as springs, may serve to bias the terminals 160 toward the digital camera 200. This biasing assures that the terminals 160 electrically contact the conductors 214 located in the digital camera 200.

A line 310 and a line 312 may connect the signal terminal 172 and the neutral terminal 174 to a processor 314. The processor 314 may serve to facilitate the transfer of data between the printer 100 and the digital camera 200 as well as facilitating printing functions. A line 315 may connect a power source to the processor 314 by way of the switch 180. As is described below, the switch 180 may serve to enable certain functions of the processor 314 to receive data from the digital camera 200. An optical transceiver 316 may be connected to the processor 314 by way of a line 318. The optical transceiver may be compatible with the optical transceiver 270 located within the digital camera 200. A line 324 may connect a data storage device 320 to the processor 314. The data storage device 320 may, as an example, be a magnetic, an optical, or a semiconductor device. Conventional printer mechanisms 326 may be connected to the processor 314 by way of a line 328. An electrical connector 330 may be connected to the processor 314 by way of a line 332. The electrical connector 330 may be adapted to electrically connect to a removable data storage device used by the digital camera 200 to store image data. For example, the removable data storage device used by the digital camera 200 may be a semiconductor device. Accordingly, the electrical connector 330 may be adapted to have the semiconductor device connected to it. Alternatively, the connector 330 may be a device that functions with other data storage devices, such as optical and magnetic media.

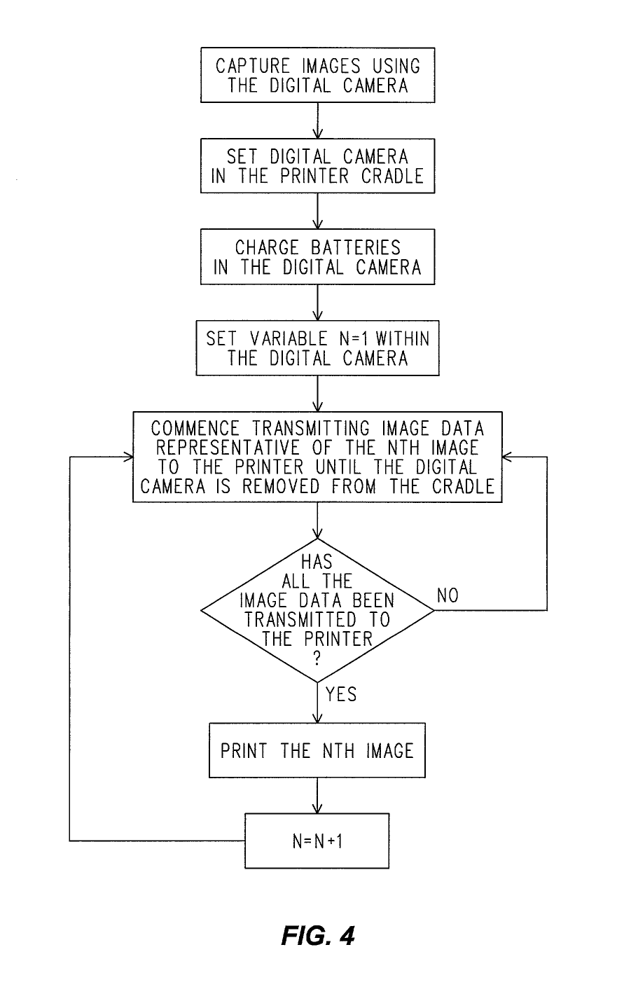

Having described the components of the printer 100 and the digital camera 200, their operation will now be described. Reference is made to FIG. 4, which is a flow chart describing a simplified non-limiting example of the operation of the printer 100 in conjunction with the digital camera 200. It should be noted that the flow chart of FIG. 4 assumes that a plurality of “N” images are marked for downloading from the digital camera 200 to the printer 100. It is to be understood that different embodiments of this downloading protocol may be used by both the printer 100 and the digital camera 200.

Referring again to FIG. 3, a user may use the digital camera 200 separate from the printer 100 to capture images of objects by converting the images of the objects to image data. The processor 264 processes the image data into a conventional format and stores the data in the data storage device 276 until the images are required to be replicated. Power for the components of the digital camera 200 is provided by the battery 258 when the digital camera 200 is not located within the cradle 150 of the printer 100. Accordingly, when the digital camera 200 is used separate from the printer 100, no current flows in the lines 250 and 252. The current sensor 254 transmits a signal to the processor 264 via the line 262 indicating that no current is passing in the lines 250 and 252. This signal indicates that the digital camera 200 is not located within the cradle 150 of the printer 100.

When a user has completed capturing images, the user sets the digital camera 200 into the cradle 150 of the printer 100. The positive conductor 220 and the ground conductor 218 of the digital camera 200 contact the positive terminal 164 and the ground terminal 166 of the digital camera 200 respectively. Likewise, the signal conductor 228 and the neutral conductor 226 of the digital camera 200 contact the signal terminal 172 and the neutral terminal 174 of the printer 100 respectively. The connections at the positive conductor 220 and the ground conductor 218 cause current to flow between the power supply 292 and the battery 258 by way of the lines connected therebetween. As shown in FIG. 3, the current also flows through the indicator 182 in the printer 100 and the current sensor 254 in the digital camera 200. The current flow through the indicator 182 causes it to illuminate, which indicates that the battery 258 is charging and that the digital camera 200 is properly positioned within the cradle 150.

When current flows through the current sensor 254, it sends a signal via the line 262 to the processor 264 indicating that the digital camera 200 is positioned in the cradle 150. The processor 264 then commences a procedure to download image data to the printer 100. The downloading procedure may, as a non-limiting example, commence with the processor 264 attempting to communicate with the processor 314 located in the printer 100 by way of the lines connected therebetween. Once the processors 264, 314 have established communication, they can transmit data between each other. For example, the processor 264 may retain a list of images that are stored in the data storage device 276. The list may include images that have not been previously downloaded to the printer 100. Accordingly, the processor 264 may commence downloading image data from the data storage device 276 that is representative of these images. In one embodiment of the digital camera 200, the user of the digital camera 200 may select images stored within the digital camera 200 that are to be printed. Image data representative of these images may then be downloaded to the printer 100 as described above. This embodiment provides for previewing of images to occur on the digital camera 200. Thus, the printer 100 only needs to print images and not edit images or image data. This allows the printer 100 to be a relatively simple device.

The processor 314 in the printer 100 receives and processes the image data. The processor 314 may also store the image data. When the image data representative of a complete image has been transmitted to the printer 100, the processor 264 in the digital camera 200 may update its list to indicate that the image data has been transmitted from the digital camera 200 or that the image has been successfully printed by the printer 100. The list prevents duplicate images from being printed every time the digital camera 200 is placed in the cradle 150. It should be noted that the printer 100 may transmit a signal to the digital camera 200 indicating that the image data has been successfully transferred. Upon receipt of this signal from the printer 100, the digital camera 200 may update its list.

When the processor 314 in the printer 100 receives the image data representative of an entire image, the processor 314 may cause the printer 100 to start printing the image represented by the image data. In one embodiment, the processor 314 in the printer 100 transmits a signal to the processor 264 in the digital camera 200 indicating that the image was printed. The image data stored within the digital camera 200 may be marked accordingly so as to notify the user of the digital camera 200 that the image was printed. For example, should the user of the digital camera 200 review the images stored within the digital camera 200, the images that have been printed may have a different background than the images that have not been printed. In one embodiment, the digital camera 200 deletes the images that have been printed. In another embodiment, the digital camera 200 downloads image data representative of a subsequent image to the printer 100 upon completion of the printing of the present image. In yet another embodiment, image data representative of several images is downloaded simultaneous with the printing of the images.

The transfer of image data from the digital camera 200 to the printer 100 may be relatively time consuming. Should a user decide to remove the digital camera 200 from the cradle 150 during the transfer of image data, the transfer of image data will be interrupted, which may corrupt the image data. This interruption problem is resolved by having the image data transferred to the data storage device 320 in the printer 100 and only updating the aforementioned list in the digital camera 200 when all the image data representative of an image is successfully transferred to the printer 100. In the event the transfer of image data is interrupted, the transfer can take place again upon a subsequent placement of the digital camera 200 into the cradle 150. When all the image data representative of an entire image has been successfully transferred to the data storage device 320, the processor 314 in the printer 100 may cause the printer mechanisms 326 to print the image in a conventional manner as described above.

Should the digital camera 200 be removed from the printer 100 during the printing process, the printer 100 may continue printing the image. Upon the digital camera 200 being returned to the cradle 150, a signal may be transmitted to the digital camera 200 to indicate the status of the printing. For example, if the image was successfully printed, the printer 100 may transmit a signal to the digital camera 200 indicating that the image has been printed. The digital camera 200 may mark the image data representative of the successfully printed image to note this status as was described above. If the image was not successfully printed, the printer 100 may transmit a signal to the digital camera 200 indicating that the image was not successfully printed and that the data representative of the unsuccessfully printed image has to be retransmitted to the printer 100.

There may be circumstances where a user does not want images printed upon setting the digital camera 200 into the cradle 150. The switch 180 provides a user with the option of having the image data downloaded and representative images printed or not. For example, closing the switch 180 may enable the processor 314 to download and print the images stored in the digital camera 200 as described above. Opening the switch 180 may disable the processor 314 from downloading and/or printing the images. The switch 180 provides a simple operation to enable the automated printing capability of the printer 100. As described above, the switch 180 may be the only user interface provided on the printer 100.

Having described a few embodiments of the printer 100 in conjunction with the digital camera 200, other embodiments will now be described.

The printer 100 has, for non-limiting illustration purposes, been described herein in some embodiments as being similar to a printer commercially available from the Hewlett-Packard Company and sold as model P1100. The printer 100 may, as a non-limiting alternative, be a printer adapted to print standard photograph-sized sheets. For example, the printer 100 may be adapted to print four inch by six inch or three inch by five inch sheets. Thus, the printer 100 may be approximately as wide as a sheet that it is adapted to print. Accordingly, the printer 100 may be between approximately three and six inches wide.

As described above, the printer 100 may be automated, wherein it automatically downloads and prints images when a camera is placed within the cradle 150. When used in this automatic mode, the buttons 122 on the control panel 120 are not required. Thus, in one embodiment of the printer 100, the printer 100 does not have a control panel 120. The printer 100 may only have the switch 180 located thereon, which serves to determine whether images are to be downloaded and/or printed. In addition, the printer 100 may have the indicator 182, which as described above, serves to notify a user that the camera is properly placed within the cradle 150.

Referring again to FIG. 3, in one embodiment, the transfer of data is performed by way of an optical means. For example, rather than use the conductors 214 in the digital camera 200 and the terminals 160 in the printer 100, light, such as infrared light, may be used to transfer image data. In this embodiment, the processor 264 transfers data to and from the optical transceiver 270. Likewise, the processor 314 in the printer 100 transfers data to and from the optical transceiver 316 located in the printer 100. Accordingly, the printer 100 and the digital camera 200 communicate by way of conventional optical means, such as infrared transmissions. The above-described optical means of transferring data may be expanded to include transmission of data by electromagnetic means, such as radio frequency transmissions.

In another embodiment, the printer 100 is connected to a computer, not shown, such as a personal computer. When the image data is transferred to the processor 314 in the printer 100, it is also transmitted to the computer. This embodiment provides for the image data to be relatively easily downloaded to the computer for subsequent processing and storage. As was described above, however, the printer 100 may be a stand-alone device that is not required to be associated with a separate computer.

In another embodiment, a switch or the like (not shown) is used to sense the presence of the digital camera 200 within the cradle 150. For example, when the digital camera 200 is set in the cradle 150, it may toggle a switch that indicates the presence of the digital camera 200 to the printer 100. The printer 100 may then commence an attempt to communicate with the digital camera 200 as was described above. Other sensing mechanisms, such as a light sensor, may be used to sense the presence of the digital camera 200 within the cradle 150.

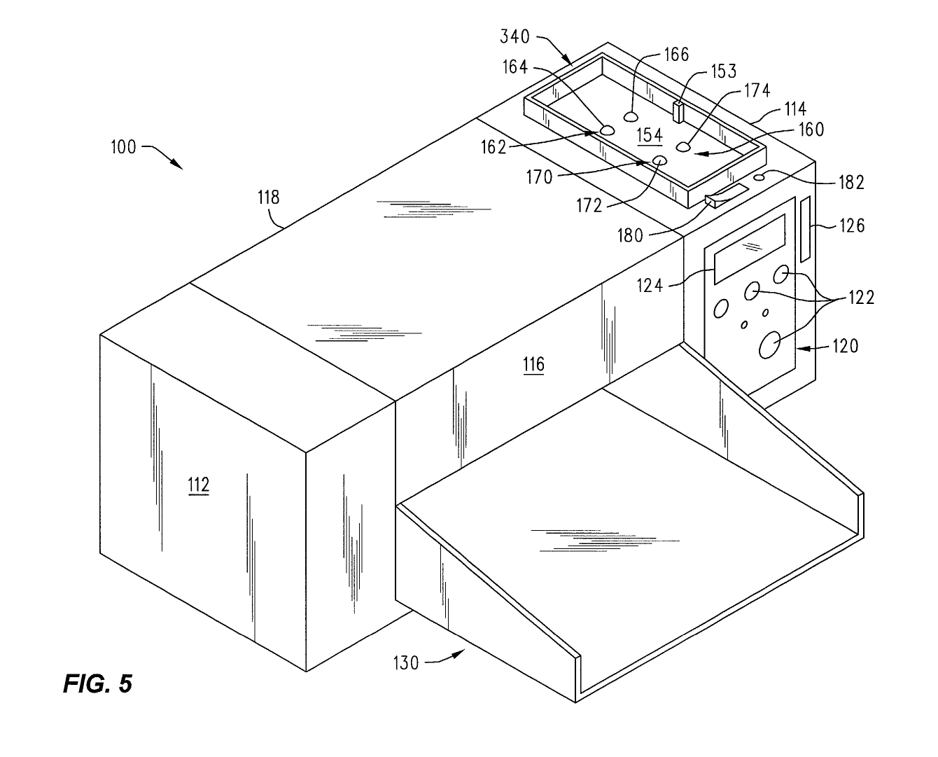

Referring to FIG. 5, the cradle 150 of FIG. 1 may be replaced by a tray 340. The tray 340 may be substantially the same size and shape of the cradle 150 of FIG. 1, however, it may extend from an exterior surface of the printer 100 rather than being recessed into the printer 100. The tray 340 may allow existing printers to be more readily retrofit to accommodate the placement of a digital camera as described above because adding the tray 340 may be easier than adding a cradle 150, FIG. 1, to an existing printer design.

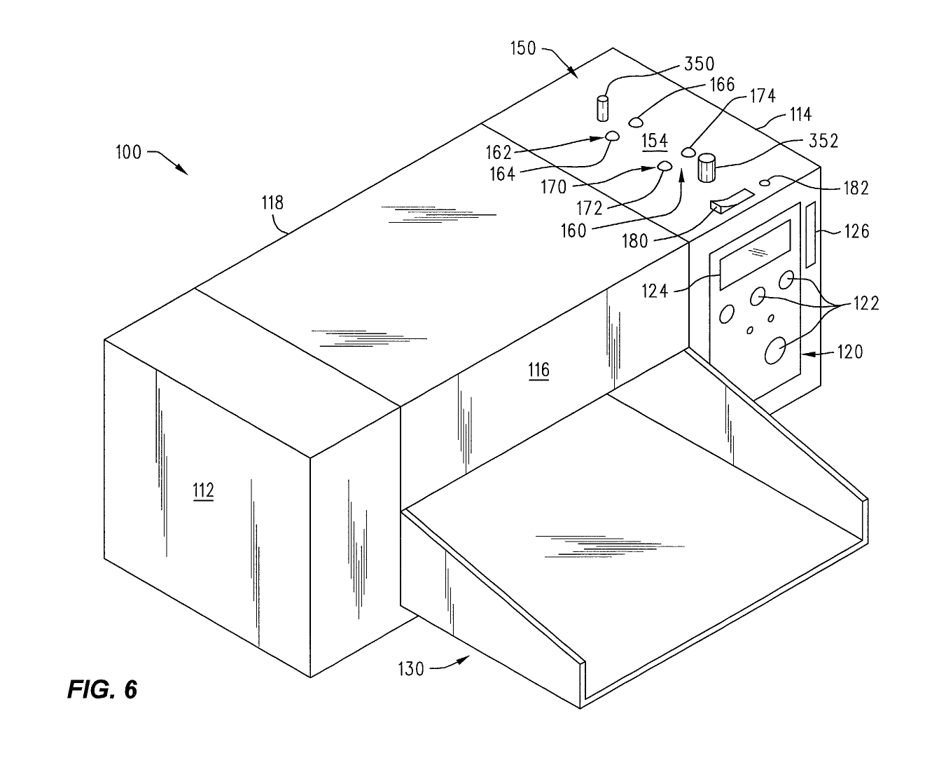

Referring to FIG. 6, the cradle 150 of FIG. 1 may be replaced by a first pin 350 and a second pin 352, which may be different sizes. The digital camera may have holes that correspond to the sizes and shapes of the pins 350, 352 and, thus, may receive the pins 350, 352. The pins 350, 352 serve to guide the digital camera relative to the printer 100 so that the above-described electrical contact is achieved. The use of two different shaped guide pins assures that the camera will only be placed onto the printer 100 in one direction so that proper electrical contact is achieved. It should be noted that the use of two different shaped guide pins is for illustration purposes only. Other configurations, such as a single pin having a key formed therein, not shown, may also be used.

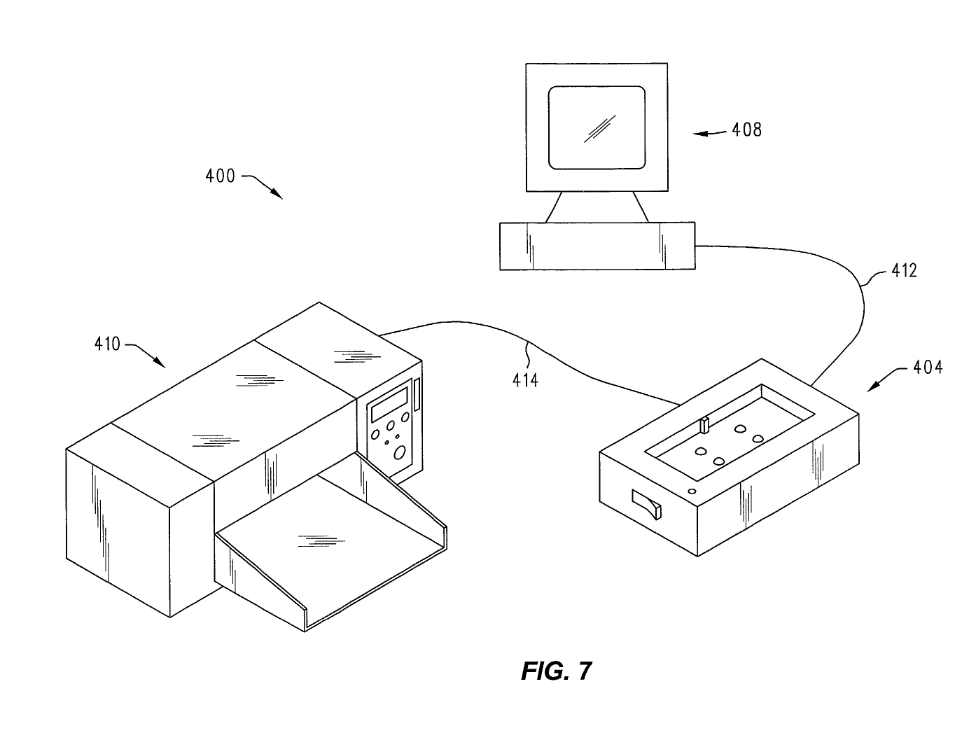

As was described above, the digital camera may be placed within a holding mechanism. An example of a computer system 400 having a separate holding mechanism 404 (sometimes referred to herein simply as the base unit 404 or a main body portion) to hold a digital camera is illustrated in FIG. 7. The computer system 400 illustrated herein has the base unit 404, a computer 408, and a printer 410. The computer 408 is connected to the base unit 404 by a line 412. The printer 410 is connected to the base unit 404 by a line 414. The base unit 404 functions in the same manner as the cradle 150, FIG. 3, except that it is located external to the printer 410. A user may set a digital camera on the base unit 404, wherein the base unit 404 facilitates the transfer of image data to either or both the computer 408 or the printer 410 as described above relative to the printer 100, FIG. 3. The base unit 404 may also serve to recharge the batteries within the digital camera. It should be noted that the base unit 404 may be a feed through with regard to conventional communications between the computer 408 and the printer 410. Accordingly, the base unit 404 will not affect these communications.

As was described above, the transmission of image data may be accomplished by the use of optical means. Accordingly, the base unit 404 may have an optical transceiver located thereon that communicates with a similar optical transceiver located on the printer 410 and/or the computer 408.

The printer 100, FIG. 1, and the base unit 404 have been described herein, in non-limiting embodiments, as functioning with digital cameras. It should be noted that printer 100, FIG. 1, and the base unit 404 may be adapted to operate with other imaging devices. For example, they may be adapted to operate and function as described above with hand-held scanning devices.

Likewise, a printer has been described herein as the electronic device to which data is transferred. It is to be understood that other devices may be used to receive the downloaded data from the imaging device. For example, the printer 100 may be replaced by a data storage device, such as a magnetic or an optical disc drive. In this embodiment, the data from the imaging device is downloaded to a storage medium associated with the data storage device as was described above with reference to the printer 100.

The data transfer between the printer 100 and the digital camera 200 has been described herein with reference to still image data. It is to be understood, however, that the data may be in other forms. For example, the digital camera 200 may be a video camera and the printer 100 may be a data storage device. Accordingly, the data transferred therebetween may be video data, such as video clips.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. An imaging device docking station comprising:
a holding portion adapted to receive an imaging device; and
a receiver adapted to receive image data from said imaging device when said imaging device is located proximate said holding portion.

2. The imaging device docking station of claim 1, wherein said holding portion is integrally formed into said imaging device docking station.

3. The imaging device docking station of claim 1, wherein said docking station comprises a main body portion and wherein said holding portion comprises a recessed portion in said main body portion.

4. The imaging device docking station of claim 1, wherein said holding portion comprises at least one pin.

5. The imaging device docking station of claim 1, wherein said holding portion comprises a first pin and a second pin, said first and said second pins having different sizes.

6. The imaging device docking station of claim 1, wherein said holding portion comprises a first pin and a second pin, said first and said second pins having different shapes.

7. The imaging device docking station of claim 1, wherein said holding portion comprises at least two electrical contacts.

8. The imaging device docking station of claim 7, wherein said at least two electrical contacts are adapted to conduct current to an imaging device when said imaging device is located within said holding portion.

9. The imaging device docking station of claim 7, wherein said at least two electrical contacts are adapted to transmit data between said receiver and an imaging device located within said holding portion.

10. The imaging device docking station of claim 1, wherein said imaging device is of the type having at least two imaging device electric contacts to receive electric power, said holding portion further comprising at least two holding portion electric contacts for delivering electric power to said imaging device, said at least two holding portion electric contacts being positioned to contact said at least two imaging device electric contacts when said imaging device is located in said holding portion.

11. The imaging device docking station of claim 1, wherein said imaging device is of the type having an imaging device transmitter associated therewith, and wherein said receiver is adapted to coact with said imaging device transmitter.

12. The imaging device docking station of claim 11, wherein said receiver comprises a radio frequency receiver.

13. The imaging device docking station of claim 11, wherein said receiver comprises an optical receiver.

14. The imaging device docking station of claim 1 and further comprising a docking station transmitter.

15. The imaging device docking station of claim 14, wherein said transmitter comprises at least one electric contact positioned within said holding portion.

16. The imaging device docking station of claim 14, wherein said docking station transmitter comprises a radio frequency transmitter.

17. The imaging device docking station of claim 14, wherein said docking station transmitter comprises an optical transmitter.

18. The imaging device docking station of claim 1 and further comprising a sensor adapted to determine the presence of an imaging device in the proximity of said holding portion.

19. The imaging device docking station of claim 1, wherein said imaging device docking station is an integral portion of a printer housing.

20. The imaging device docking station of claim 1, wherein said imaging device docking station is an integral portion of a data storage device.

21. The imaging device docking station of claim 20, wherein said data storage device comprises a magnetic data storage device.

22. The imaging device docking station of claim 20, wherein said data storage device comprises an optical data storage device.

23. The imaging device docking station of claim 1, wherein said imaging device is of the type having a battery located therein and an electric contact extending between said battery and an exterior surface of said imaging device, and wherein said imaging device docking station further comprises an electrical contact located thereon that is adapted to contact said imaging device electric contact when said imaging device is located in said holding portion, and wherein said imaging device docking station electric contact is adapted to operate at a power that charges said battery.

24. The imaging device docking station of claim 1 and further comprising a computer and a computer-readable medium operatively associated with said computer, said computer-readable medium containing instructions for controlling said computer to download data from an imaging device by:
detecting the presence an imaging device in the proximity of said holding portion;
transmitting an instruction to said imaging device to initiate said downloading of data; and
receiving said data downloaded by said imaging device.

25. The imaging device docking station of claim 24, wherein said computer-readable medium contains further instructions for detecting downloaded data representative of a whole image.

26. The imaging device docking station of claim 24, wherein said instructions further comprise:
determining whether said data has been completely downloaded; and
transmitting a signal to said imaging device indicative of whether said data has been completely downloaded.

27. The imaging device docking sation of claim 24, wherein said imaging device docking station is a printer and wherein said instructions further comprise printing an image representative of said data.

28. The imaging device docking sation of claim 24 and further comprising transmitting a signal to said imaging device indicating that said image was printed.

29. A method for transferring data from an imaging device to an electronic device, said method comprising:
locating said imaging device in the proximity of said electronic device;
detecting the presence of said imaging device in said proximity of said electronic device; and
transferring said data from said imaging device to said electronic device upon said detection of said imaging device in said proximity of said electronic device.

30. The method of claim 29, wherein said data is image data representative of an image and further comprising deleting said image data from said imaging device subsequent to the complete transfer and processing of said image data to said electronic device.

31. The method of claim 29, wherein said transferring said data comprises transferring said data through an electrical connection between said imaging device and said electronic device.

32. The method of claim 29, wherein said transferring said data comprises transferring said data by way of an optical link between said imaging device and said electronic device.

33. The method of claim 29, wherein said transferring said data comprises transferring said data by way of a radio frequency link between said imaging device and said electronic device.

34. The method of claim 29, wherein said data is representative of an image, and further comprising maintaining a list of images that have been transferred to said electronic device.

35. The method of claim 34, wherein said electronic device is a printer and wherein said maintaining a list further comprises maintaining a list of images that have been printed by said printer.

36. The method of claim 29 and further comprising providing power to said imaging device by way of said electronic device.

37. The method of claim 29 and further comprising mounting a battery in said imaging device and charging said battery.

38. The method of claim 29, wherein said transferring data to said electronic device comprises transferring said data to a printer.

39. The method of claim 38 and further comprising printing an image represented by said data with said printer.

40. The method of claim 38 and further comprising printing an image represented by said data with said printer after data representative of a whole image is transferred to said printer.

41. The method of claim 29, wherein said transferring data to said electronic device comprises transferring data to a data storage device.

42. The method of claim 29, wherein said transferring data from said imaging device comprises transferring data from a digital camera.

43. A printer comprising:
means for holding an imaging device;
means for detecting the presence of said imaging device within said holding means;
means for transferring data from said imaging device to said printer; and
means for printing an image representative of said data.

44. The imaging device docking station of claim 43 and further comprising means, provided on said holding means, for supplying power to an imaging device in response to detection of said imaging device by said detecting means.
